(19) United States
(12) Patent Application Publication
(10) Pub. No.: US 2022/0297225 A1
(43) Pub. Date: Sep. 22, 2022

(54) POWER SOURCE MODULE FOR JOINT PROCESSES

(71) Applicant: NIMAK GmbH, Wissen (Sieg) (DE)

(72) Inventors: Johannes STEUDTER, Oberahr (DE); Bernd RÖDDER, Honigsessen (DE); Olaf TÜNKERS, Ratingen (DE)

(73) Assignee: NIMAK GmbH, Wissen (Sieg) (DE)

(21) Appl. No.: 17/699,760

(22) Filed: Mar. 21, 2022

(30) Foreign Application Priority Data
Mar. 22, 2021 (DE) 102021107020.1

(51) Int. Cl. B23K 11/31; B23K 11/24; B23K 11/30

(52) U.S. Cl. CPC B23K 11/314; B23K 11/241; B23K 11/3054

(57) ABSTRACT

A current source module for joining methods with current-generated heat support that includes a base body formed monolithically as a single component, having a first immovable attachment element for connecting a first joining tool and at least one formed first receiving space. In the first receiving space, a control element is disposed including a linearly movable second attachment element for connecting to a second joining tool, and in the first or additional receiving space a transformer unit for electrical supply is disposed. Furthermore, a welding gun is provided that includes such current source module, and a first joining tool formed as an immovable electrode arm, and a second joining tool formed as a movable electrode arm, wherein the immovable arm is connected to the first attachment element and the movable arm is connected to the second linearly movable attachment element, wherein the electrode arms include electrodes connected to the transformer.

### CROSS REFERENCE TO RELATED APPLICATIONS

This application claims the benefit of priority under 35 U.S.C. § 119 to German Patent Application No. 10 2021 107 020.1, filed Mar. 22, 2021, the contents of which is incorporated herein by reference in its entirety.

### FIELD

The invention relates to a current source module for joining processes with current-generated heat support, in particular for welding guns for electric spot welding. Furthermore, the invention relates to a welding gun that includes such a current source module.

### BACKGROUND

The statements in this section merely provide background information related to the present disclosure and several definitions for terms used in the present disclosure and may not constitute prior art.

In DE 20 2011 052 206 U1 a base is disclosed for a robot welding gun for electric spot welding. This includes a carrier including an associated drive for retaining a fixed electrode holder and a movable electrode holder. Furthermore, a welding transformer is disposed on the carrier. The carrier is composed of two identical side plates that form between them, in mutually parallel spaced arrangement, a receiving space for the retainers and the welding current transformer. Here this receiving space is held as open as possible in order to ensure the accessibility to the retainers and the welding current transformer, etc. Here the side plates of this base body include a plurality of hole openings, so that the retainers and the welding transformer can be installed in the base body in the largest possible number of installation positions. In particular, the base body is thereby configurable for use in a C welding gun and for use in an X welding gun by a rearrangement of the individual components. A construction or conversion of a welding gun that includes such a base body is therefore complex and cumbersome, which increases the potential for error.

The current source modules include carrier elements, e.g., two carrier plates such as disclosed in DE 202011 052 206 U1, or a carrier, as disclosed in DE 20 2008 013 881 U1, wherein the carrier includes no receiving space, with the result that the individual components are disposed around the carrier attached to the carrier. Furthermore, the components disclosed in the currently known source modules are disposed on the carrier, therefore depending on the area of use each component must have its own housing or its own protective sleeve for shielding against the environment.

In DE 20 2006 016 466 U1 a base unit is disclosed for a welding gun for electric spot welding. In this base unit certain functional components are disposed together in a housing. This housing encloses the functional components, wherein the functional components themselves are disposed inside the housing on a carrier element. A complex construction having a high number of components also results therefrom.

Furthermore, welding guns are known wherein the control element is driven linearly using a pneumatic/hydraulic drive system. However, this method of the drive has a high energy requirement.

Therefore, an object of the present disclosure is to provide a novel current source module that has a simpler handling, in particular a simpler constructing/converting and simple use.

### SUMMARY

The objective of the present disclosure is achieved by a current source module having the features comprising a base body formed monolithically as a single component, which has a first immovable attachment element for connecting a first joining tool and at least one first formed receiving space, wherein in the first receiving space a control element is disposed including a linearly movable second attachment element for connecting to a second joining tool, and in the first or a further receiving space a transformer unit is disposed for electrical supplying of the joining tool.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 shows a perspective view of a base body of a current source module according to the teachings of the present disclosure;

FIG. 2 shows a schematic representation of a first embodiment of a current source module;

FIG. 3 shows a schematic representation of a second embodiment of a current source module;

FIG. 4 shows a schematic representation of a third embodiment of a current source module;

FIG. 5 shows a schematic representation of a fourth embodiment of a current source module;

FIG. 6 shows a schematic representation of a current source module including a cooling circuit;

FIG. 7 shows a perspective view of a C welding gun including a current source module according to the teachings of the present disclosure;

FIG. 8 shows a perspective view of an X welding gun including a current source module according to the teachings of the present disclosure; and

FIG. 9 shows a perspective view of the X welding gun from FIG. 8 without a current source module according to the teachings of the present disclosure.

The drawings are provided herewith for purely illustrative purposes and are not intended to limit the scope of the present invention.

### DETAILED DESCRIPTION

The following description is merely exemplary in nature and is in no way intended to limit the present disclosure or its application or uses. It should be understood that throughout the description, corresponding reference numerals indicate like or corresponding parts and features.

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

The source module of the present disclosure generally includes a base body, formed monolithically as a single component, which has a first immovable attachment element for connecting a first joining tool and at least one formed first receiving space. In the first receiving space a control element is disposed including a linearly movable second attachment element for connecting to a second joining tool. Furthermore, in the first or a further receiving space a transformer unit is disposed for electrical supplying of the joining tool.

Since the current source module includes a base body formed monolithically as a single component that includes a first immovable attachment element for connecting a first joining tool, and at least one first formed receiving space, the complexity of the current source module is reduced. In particular, according to one aspect of the present disclosure, the first immovable attachment element is an element of the base body itself, and not a functional component that is disposed repositionably on the base body in a modular manner. The first joining tool is thereby advantageously directly connected to the base body. In addition, due to the monolithic embodiment of the base body, at least one receiving space is provided without a plurality of components, e.g., carrier plates or separate housings, having to be connected to each other. Both the number of the components and the effort of handling are therefore reduced or simplified.

In the first receiving space a control element is disposed, including a linearly movable second attachment element for connecting to a second joining tool, so that the current source module can move the second joining tool relative to the first joining tool, which is advantageous in particular for the use of the current source module in a welding gun. Furthermore, in the first or a further receiving space a transformer unit is disposed for electrical supplying of the joining tool.

The transformer unit is comprised in particular of a primary coil, a secondary coil, and a transformer core. The base body can particularly advantageously be configured such that individual receiving spaces are provided for different components. In particular with respect to the clarity and the simpler assembly, a separating of the components is advantageous in that, for example, the risk of damage to the components to be installed or installed is reduced during a constructing/converting or maintenance. In addition, different cooling zones adapted to the respective components can thereby be provided in a simple manner.

According to a further aspect of the present disclosure, the monolithic base body can be configured such that a thermal conduction can occur via the base body itself, so that in particular, heat generated, for example, by the transformer unit can be discharged faster from the receiving space.

Conventional transformer units are cast in a housing. The coils are disposed, already cast as a unit, on a carrier element as a modular component. According to one aspect of the present disclosure, the transformer unit is connected to the base body in a materially-bonded manner. Due to the materially-bonded connecting of the transformer unit in or to the receiving space, the base body forms a unit with the transformer unit, so that incorrect installations are prevented.

In particular, the transformer unit is cast in a receiving space of the base body. The transformer unit is thereby advantageously disposed extensively abutting against multiple walls of the receiving space. In addition to the advantage that the transformer unit is thereby disposed in the base body in a custom-fit manner, this embodiment results in a particularly good heat transmission from the transformer unit to the base body.

In order to further optimize the handling and to avoid errors, a rectifying device may be disposed in the first or a further receiving space and electrically connected to the transformer unit.

The rectifying device advantageously includes diodes, which are accessible from outside the base body and replaceable. For this purpose in a wall of the receiving space wherein the rectifying device is disposed, the base body can advantageously have an opening, so that a user receives easy access to the diodes to be replaced.

In particular, the opening can be configured such that the user has no or only limited access to the rest of the receiving space or to the other components. A faulty exchange of the diodes is thereby prevented, and the exchange process itself can take place in an almost intuitive manner.

For the linear movement of the second attachment element, a drive unit is may be disposed in active connection to the control element on the base body, so that the control element can move the second attachment element linearly. In principle, the control element can also be connected to a drive unit separated from the base body. With respect to the handling, the movement-/force-transmission from an external drive unit can be disadvantageous. In particular, with an electric motor or a magnetic linear drive as a drive unit, it has proven to be particularly advantageous when the electric motor or magnetic linear drive is in particular directly disposed or installed on the base body itself, since in particular the weight distribution is thereby favorably influenced.

The control element may be configured as a spindle, and the drive unit as an electric motor. The spindle advantageously converts a rotational movement of the electric motor into a linear movement of the second attachment element. As described above, here the electric motor may be advantageously connected to the base body, in particular directly.

According to an alternative embodiment, the drive unit is configured as a magnetic linear drive, which can linearly move the control element and the second attachment element. This embodiment can also be improved by the magnetic linear drive being in particular directly connected to the base body. Here the magnetic linear drive is directly connected to the second attachment element, and contains the control element as part of the drive. In particular, the magnetic linear drive replaces the spindle, a transmission, and a drive gear that can incur in an embodiment of the drive unit as electric motor.

According to another aspect of the present disclosure, a transmission is in active connection to the drive unit, and translates the movement of the drive unit to the control element.

It has been advantageously shown that the transmission and/or the drive unit is/are disposed in the first and/or a further receiving space of the base body. This is to be preferred in particular for a heat discharge from the receiving space/spaces, since in operation the transmission and the drive unit regularly generate heat, which is poorly discharged in an air-insulated housing.

In this sense it is advantageous when the base body includes two, in particular three, receiving spaces, wherein in the second receiving space at least the transformer unit is disposed, and in a first receiving space at least the linearly movable control element is disposed. The drive unit and the transmission may be disposed in the second or a third receiving space, or a third and a fourth receiving space.

The function of the current source module or of a tool subassembly containing the current source module, for example, a welding gun, can be improved by the base body including at least one cooling channel that can guide a fluidic coolant. In particular, the cooling channel makes possible a heat removal from at least one receiving space, in particular a heat energy generated by the transformer unit or by formed power rails and transmitted to the base body. An effective cooling is thereby synergetically provided by the above-mentioned features.

Furthermore, it is possible to provide the individual components with cooling elements and a plurality of coolant lines. The installation space requirement is thereby disadvantageously increased, and the clarity and complexity are disadvantageously influenced. The integration of the cooling channels into the base body also has the advantages that no cooling lines can kink or be damaged. In addition, the need for individual cooling elements on the respective components is eliminated, so that the cooling is affected synergetically via the base body via the arrangement of the individual components in the receiving opening(s). The integration of cooling channels in a conventional base body was not possible from the prior art.

In particular, it is therefore advantageous when at least one cooling channel is formed in at least one wall, advantageously in a plurality of walls, preferably in all walls of the base body, which wall/walls surrounds/surround the first receiving space and/or further receiving spaces.

Furthermore, it is beneficial that at least one cooling channel is formed in at least one separating wall of the base body, which separating wall separates two receiving spaces from each other. In particular, this embodiment makes possible the partial cooling of two receiving spaces.

According to another embodiment of the present disclosure, at least one cooling channel is formed in the base body such that at least two receiving spaces are surrounded by the same cooling channel at least on one side, and the receiving spaces are thermally coupled to each other by the cooling channel. Each receiving space can advantageously be cooled by a single cooling channel.

In particular, the base body can also include a plurality of cooling channels fluidically separated from each other that are connected in parallel or completely independent of one another. Furthermore, the cooling channels can be configured such that they extend through the base body in a meandering manner, in particular at least through one wall of at least one receiving space.

A tool subassembly for which the current source module according to one of the above-mentioned embodiments is particularly suited is a welding gun.

A welding gun includes in particular a current source module of the above-mentioned type. Furthermore, the welding gun includes a first joining tool formed as an immovable electrode arm, and a second joining tool formed as a movable electrode arm, wherein the immovable electrode arm is connected to the first attachment element, and the movable electrode arm is connected to the second linearly movable attachment element. The electrode arms include electrodes, wherein the electrodes are electrically connected to the transformer unit via the rectifying device. According to one objective underlying the invention, a welding gun is thereby provided that is characterized by a simpler handling and lower susceptibility to errors in comparison to the prior art.

In particular, the welding gun is formed as a C gun. Together with the base body, the immovable electrode arm forms a C-shape. The control element includes the second attachment element, linearly movable along an adjustment axis, wherein the movable electrode arm is formed on the attachment element. Using the control element, the movable electrode arm can thereby move parallel to the adjustment axis into a joining position and a rest position. In the joining position at least two components to be welded, in particular metal plates, are advantageously impingeable by the welding electrodes with a contact force and with electrical energy for welding, provided by the transformer unit, via the rectifying unit.

According to a further embodiment, the welding gun is configured as an X gun, wherein the immovable electrode arm includes a rotating bearing, and the movable electrode arm is rotatably supported on the immovable electrode arm via the rotating bearing. In contrast to the prior art, the rotating bearing is thereby not disposed on the base body, but rather on the immovable electrode arm. The movable electrode arm is further preferably pivotably connected by a swing arm to the second attachment element of the control element, so that using the linear movement of the second attachment element the movable electrode arm is rotated about the rotating bearing on the immovable electrode arm, and a height displacement of the connection of the swing arm to the movable electrode arm relative to the second attachment element is compensated for by the swing arm. The movable electrode arm or the electrode disposed on the movable electrode arm is thereby advantageously transferable along a circular path into a joining position and a rest position, wherein in the joining position, as described above, the components can be pressed against each other and welded to each other with electrical energy.

The electrodes of the welding gun can be fluidically cooled individually or together in a cooling circuit. According to one advantageous embodiment, the current source module includes at least one cooling channel.

This cooling channel is preferably fluidically connected to at least one cooling channel of the movable electrode arm and/or one cooling channel of the immovable electrode arm. In particular, the cooling channels or the at least one cooling channel for cooling the respective electrode are or is formed extending along the respective electrode arm up to the electrode. The cooling channel can form a forward course and a return course for each electrode arm. In one special embodiment, an electrode arm is connected to a cooling channel formed as a forward course, and the other electrode arm is connected to a cooling channel formed as a return course, wherein the cooling channels of the electrode arms are connected to each other, externally of the current source module, via a cooling bridge. The respective electrode arm can also include guide means, e.g., a groove or arms, in order to guide a hose line along the electrode arm. The hose line can in particular replace or supplement a cooling channel in the electrode arm. For example, the supply and return course on the cooling channel can be divided into the electrode arm and a hose line along the electrode arm.

Further advantageous designs of the invention arise from the following Figure descriptions together with the description of the associated embodiments described therein. In the various Figures of the drawings identical parts are always provided with the same reference numbers.

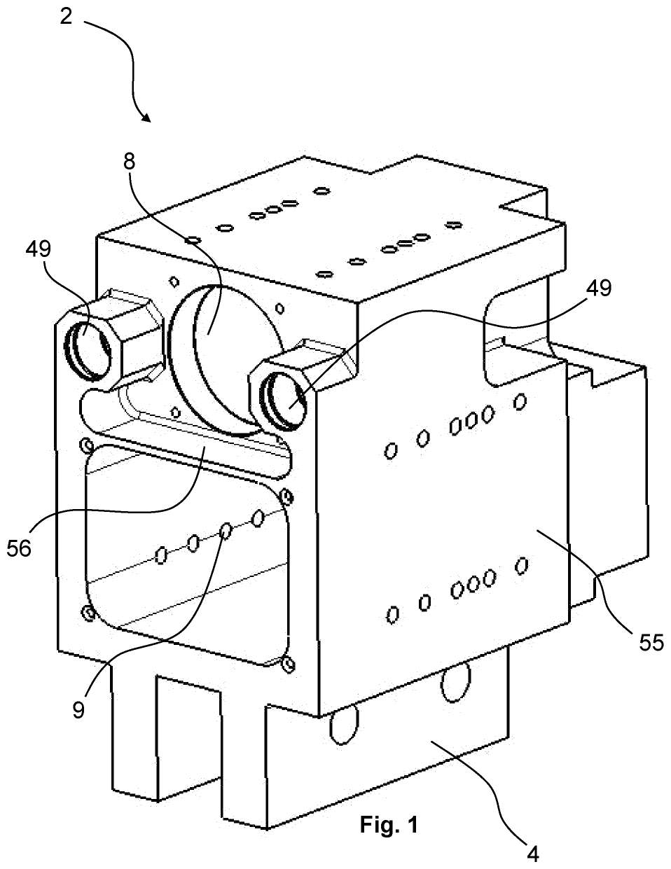

FIG. 1 shows an inventive monolithic base body 2 of a current source module 1 according to the teachings of the present disclosure.

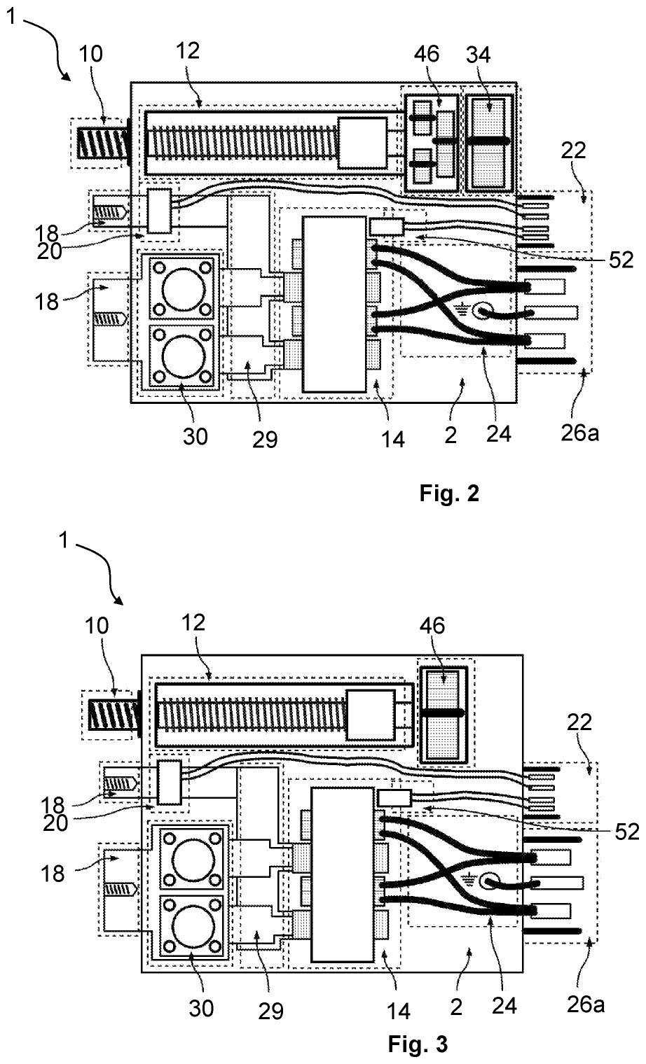

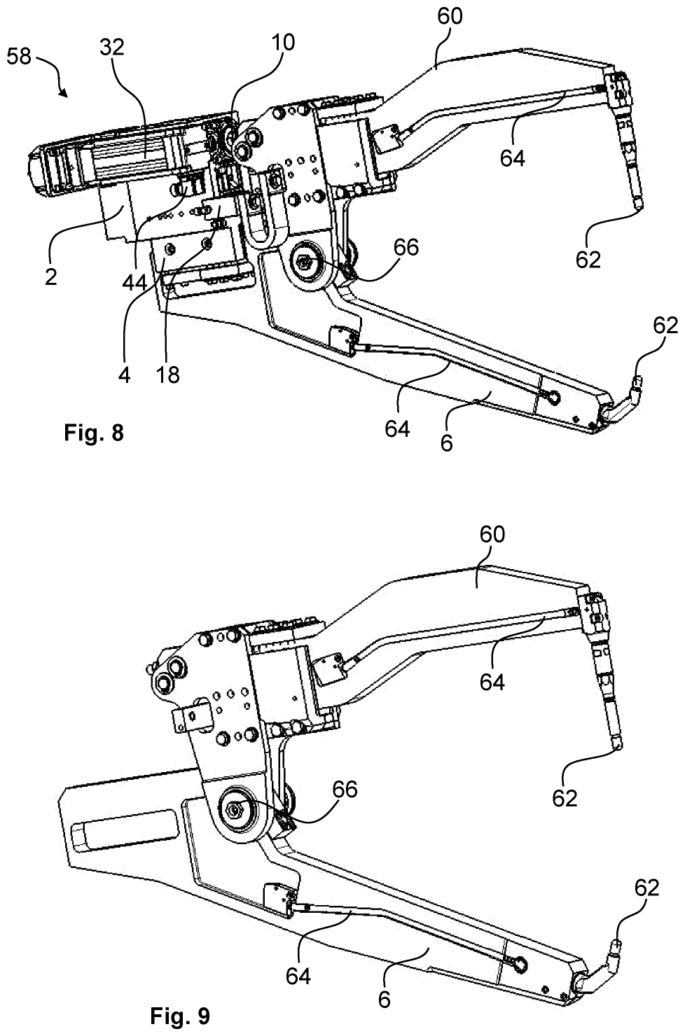

FIGS. 2 to 6 respectively show a schematic representation of a current source module 1 for joining methods with current-generated heat support. For example, in FIGS. 7 and 8, preferred applications are depicted of the current source module 1 in welding guns, in particular for electric spot welding.

The current source module 1 includes the base body 2, formed monolithically as a single component, which is depicted in FIG. 1. As depicted in FIG. 1, the base body 2 furthermore has a first immovable attachment element 4 for connecting a first joining tool. By way of example, in FIGS. 7 and 8 an immovable electrode arm 6 as a first joining tool is directly attached to the base body 2.

The monolithic base body 2 is composed in particular of a metallic material, preferably of steel or aluminum or of a steel- or aluminum-alloy. In order to save weight, it has usefully been proven as advantageous to form the base body 2 from plastic.

As depicted in FIG. 1, the base body 2 also has at least one first receiving space 8, wherein in the first receiving space 8 a control element is disposed with a linearly movable second attachment element 10 for connecting to a second joining tool. The schematic representations of FIGS. 2 to 6 show the control element in particular in a variant embodied as a spindle 12.

In the first or a further receiving space 8, 9, a transformer unit 14 is disposed for electrical supplying of the joining tool, as schematically depicted in FIGS. 2 to 5. The transformer unit 14 is composed in particular of a primary coil, a secondary coil, and a transformer core. For use in a spot welding method, the transformer unit 14 is preferably supplied with alternating voltage with frequencies of 500-20,000 Hz by an upstream converter 16.

For electrical contacting of the joining tool with the transformer unit 14, the current source module 1 or the base body 2 preferably includes power terminals 18 accessible from outside the current source module 1. The power terminals 18 are advantageously connected via the rectifying device to the secondary side of the transformer unit 14 by electrical conductors. In particular, the current source module 1 includes two power terminals 18, a positive terminal and a negative terminal, which are in particular configured as screw-, clamp-, or plug-connectors. A current measurement coil 20 is advantageously connected to the lines connecting the power terminals 18 to the secondary side of the transformer unit 14, wherein the signals of the current measurement coil 20 are in particular retrievable via a control-line plug 22, which is preferably accessible from outside the current source module 1.

In accordance with FIGS. 2, 3 and 5, the converter 16 can be disposed separately from the current source module 1, usually a not-depicted control cabinet. Here the current source module 1 includes an electrical primary circuit 24 that connects the transformer unit 14 to a supply terminal. The supply terminal is preferably formed as a primary plug 26a at a position accessible from outside the current source module 1.

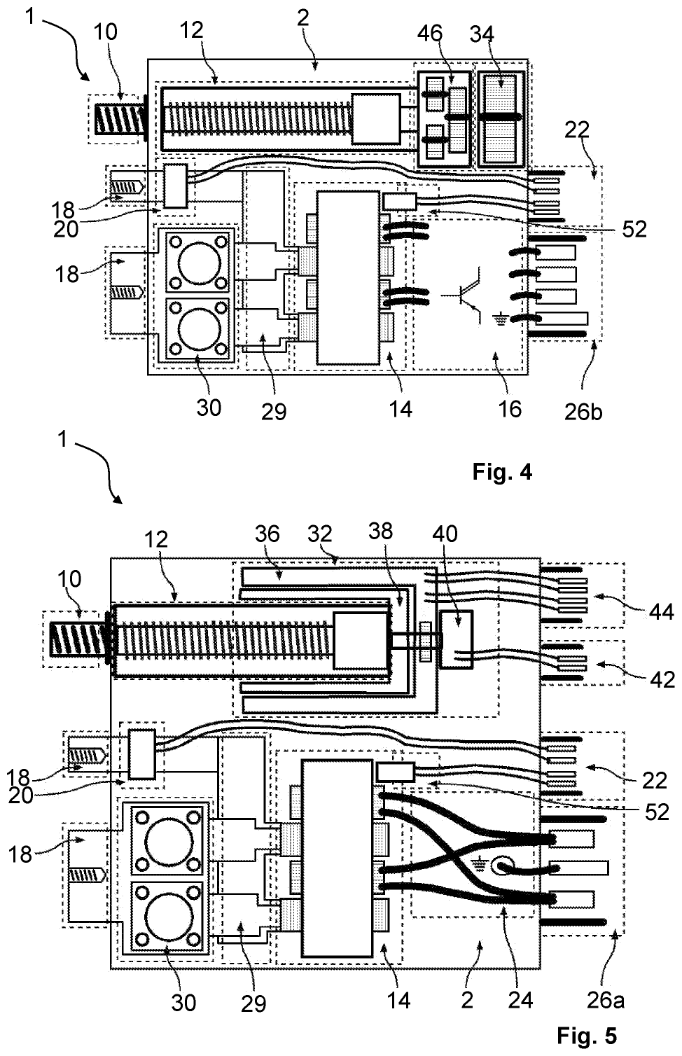

In the embodiment according to FIG. 4, the converter 16 is integrated in the current source module 1 or in the monolithic base body 2. An electrical primary circuit 26 between a supply terminal and the transformer unit 14 can thereby be omitted, and the converter 16 directly connected to the transformer unit 14 by electrical lines. The supply terminal is preferably also, in a manner similar to in the above-mentioned example, formed as a primary plug 26b at a position accessible from outside the current source module 1. A three-phase alternating voltage supply with additional ground terminal preferably abuts against the primary plug 26b.

According to another variant of the present disclosure, the electrical components for generating a welding current, in particular the transformer unit 14, the converter 16, and a rectifying device, are each embedded separately from one another, in individual components, in the monolithic base body 2. From the prior art it is known to at least partially combine the electrical components as a subassembly having a common housing and to attach them to a carrier. However, in light of the present disclosure, such a grouping is disadvantageous since a large installation space must be provided, and the heat development is increasingly centered. The advantageous arrangement in the monolithic base body 2 makes possible an equalizing and separating of the electrical components so that no housing is required for the respective components, the installation space of the receiving space 8, 9 is ideally used, and the heat generation can be distributed over a more widely dispersed space and transmitted to the base body 2.

The transformer unit 14 may be connected to the base body 2 in a material-bonded manner. Due to the material-bonded connection of the transformer unit 14 to the base body 2, a releasing and an incorrect replacing is prevented. In particular, the connection is configured such that a destruction-free separating of the transformer unit 14 from the base body 2 is not possible or is only possible with extreme difficulty. Faults and defects with respect to the arrangement and mounting can thereby advantageously be recognized more easily.

The transformer unit 14 is preferably cast in the receiving space 8, 9, so that the cured casting compound is connected in a materially-bonded manner to the base body 2 or the receiving space 8, 9. It is known from conventional transformer units that they are cast in a housing. These pre-assembled transformer units are used in order to be inserted and installed in current source modules of the known type. Due to the direct casting of the transformer unit 14 in the receiving space of the base body 2, a separate housing for the transformer unit 14 is not required. Furthermore, the arrangement and the cooling of the transformer unit 14 as well as the weight of the current source module 1 are improved. In particular, the casting compound can be a suitable casting resin.

In accordance with the schematic depictions of FIGS. 2 to 5, according to a variant of the present disclosure a rectifying device may be disposed in the first or a further receiving space 8, 9, and electrically connected to the transformer unit 14. In an improved embodiment, the rectifying device 30 may include diodes that are accessible from outside the base body 2 and configured to be replaceable individually or together. In the embodiment of the base body 2 in FIG. 1, the transformer unit 14 and the rectifying device are respectively disposed separately from each other in a second receiving space 9, and electrically connected by power-terminal connections. In particular, the second receiving space 9 is accessible front-side and rear-side, so that the second receiving space 9 is formed as an opening leading through the base body 2. In particular, in the embodiment of the base body 2 according to FIG. 1, the diodes are installable and removable front-side of the base body 2, in particular using electrical plug contacts.

In a not-depicted example, the base body 2 may include an opening in a side wall of the second receiving space, so that the diodes are accessible perpendicular to the second receiving space 9. In particular with installed joining tools, the access to the diodes is thereby facilitated.

According to an also-not-depicted embodiment, the diodes may be disposed in their own further receiving space that includes a separate access for a user in the base body 2.

In particular, a rectifying circuit may be used in the form of 2, 4, 6, or 8 rectifying diodes.

The current source module 1 preferably includes a drive unit that is disposed in active connection to the control element 2, so that the control element can move the second attachment element 10 linearly. In the schematic FIGS. 2 to 5, different possibilities for implementing the drive with an electric motor 32 are depicted. FIG. 5 shows here an embodiment, according to which the drive unit is disposed together with the control element in a receiving space 8 of the base body 2. However, the invention is not limited to an electric motor 32 as a drive unit.

In particular, the drive unit, for example, the electric motor 32, can be installed outside the base body 2, as can be seen in FIGS. 7 and 8, directly on the base body 2.

The control element may be advantageously configured as a spindle 12, and the drive unit as an electric motor 32, as depicted in FIGS. 2 to 5. The spindle 12 preferably converts a rotational movement of the electric motor 32 into a linear movement of the second attachment element 10.

In addition, as depicted in FIGS. 2 to 4, the spindle 12 can include a drive gear 34, into which a corresponding gear on the drive unit can engage. Alternatively, the spindle 12 can be connected to the drive unit via a toothed belt that interacts with the drive gear 34. The connections using the drive gear 34 provide a simplified movement-/force-transmission of the drive unit.

In FIG. 5 an advantageous variant of a drive unit formed as an electric motor 32 is depicted with a spindle 12 as a control element. In particular, the electric motor 32 together with the spindle 12 is embedded in a receiving space 8 of the base body 2. The electric motor 32 advantageously includes a stator 36 and an armature 38 that respectively enclose a section of the spindle 12. Here an axle connected to the spindle 12 is connected to a positional location sensor 40, so that the movement of the spindle 12 can be measured, or in particular the linear movement of the second attachment element 10 can be determined.

As depicted in FIG. 5, the current source module 1 preferably includes a first plug connector 42 accessible from outside, which is electrically connected to the positional location sensor 40 so that a receiving device, e.g., a control computer, can be connected to the positional location sensor 40 via a mating connector.

As depicted in FIG. 5, the current source module 1 advantageously includes a second plug connector 44 accessible from outside, which is electrically connected to the electric motor 32. Via the plug connector the electric motor 32 can be supplied with current, and the motor power can be adjusted using a corresponding motor control.

The positional location sensor 40 and the current supply for the electric motor 32 are not depicted in the embodiments of FIGS. 2 to 4. It falls within the context of the invention that the embodiments depicted in FIGS. 2 to 4 also include a corresponding current supply and/or a corresponding positional location sensor 40. In particular, the positional location sensor 40 is also not limited to use with an electric motor 32, but rather can also be implemented in alternative, in particular the following, drive concepts.

According to a not-depicted variant, the drive unit is an electromagnetic linear drive that can move the control element and the second attachment element 10 linearly. This drive unit is particularly suitable to be installed directly on the base body 2, preferably in a receiving space 8 of the base body 2. Here the magnetic linear drive is preferably directly connected to the second attachment element 10, and contains the control element as part of the drive. In particular, the magnetic linear drive replaces the spindle 12, a transmission 46, and a drive gear 34 that can incur in an embodiment of the drive unit as electric motor 49.

A transmission 46 preferably is in active connection to the drive unit that translates a movement of the drive unit to the control element, and can in particular adjust the movement at the control element. For example, in the embodiments shown in FIGS. 2 and 4, a transmission 46 is interposed between a drive gear 34 and the spindle 12, so that the drive values transmitted to the drive gear 34 from the drive unit are converted into output values adapted to the spindle 12.

The transmission 46 and/or the drive unit is advantageously disposed in the first and/or further receiving space 8, 9 of the base body 2. The base body 2 depicted in FIG. 1 includes two receiving spaces 8, 9. It is schematically depicted in FIGS. 2 and 4 that in the first receiving space 8 the spindle 12 and a transmission 46 are disposed together. In the exemplary embodiment according to FIG. 3, only the spindle 12 is disposed in the first receiving space 8. According to the embodiment in FIG. 5, the spindle 12 and the electric motor 32 are disposed in the first receiving space 8.

FIGS. 1 to 5 show a base body 2 that includes only two receiving spaces 8, 9.

Even when not depicted, a further separating or another dividing of the individual above-mentioned components falls within the context of the invention. In particular, the base body 2 includes three receiving spaces.

FIGS. 2 to 5 show an advantageous dividing, wherein in the second receiving space 9 at least the transformer unit 14 and in a first receiving space 8 at least the linearly movable control element are disposed.

According to the exemplary embodiment of the base body 2 in FIG. 1, the first receiving space 8 is configured as cylindrical. The cylindrical shape is particularly advantageous for the arrangement of a cylindrical control element. The second receiving space 9 is advantageously configured cuboid-shaped, whereby a very clear installation space is provided, which is suited in particular for precise positioning and connecting of the electrical components, and can subsequently be advantageously completely or partially cast with a casting compound. For simple casting of the components in the respective receiving space 8, 9, the base body 2 preferably includes at least one inlet channel for the transport of the casting compound in its wall 55, which opens into at least one receiving space 8, 9.

Furthermore, it can be seen in FIG. 1 that the base body 2 preferably includes two guide spaces 49 for the arranging of support element 50. These support elements 50 serve in particular to carry or support a joining tool, and to release the second attachment element 10 and the control element connected to the attachment element 10. FIG. 7 shows here such a releasing, wherein the control element is released as described by the support element 50 receiving a large part of the load and transmitting it to the base body 2.

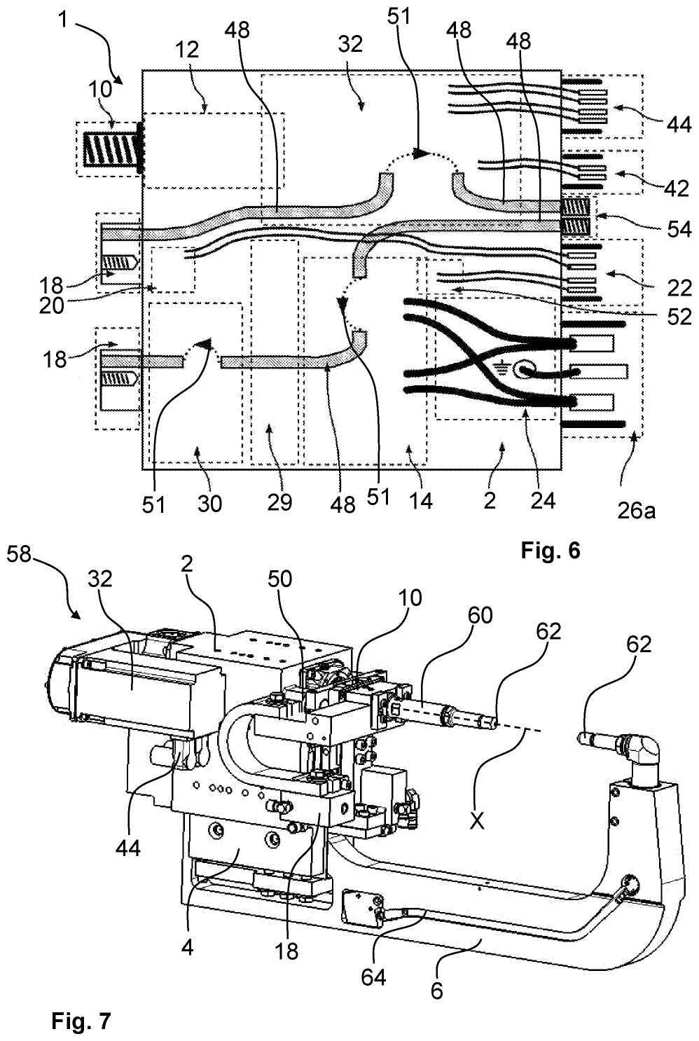

Another variant of the current source module 1 is depicted in FIG. 6. The embodiment depicted in FIG. 6 is characterized by a very effective cooling device. FIG. 6 shall illustrate the cooling device here and can in particular be combined with all above-mentioned embodiment variants. The current source module 1 depicted in FIG. 6 is leaned against the current source module 1 that is depicted in FIG. 5.

The base body 2 advantageously includes at least one cooling channel 48 in a manner corresponding to FIG. 6. The example in FIG. 6 includes at least two cooling channels 48. The cooling channel 48 can guide a fluidic coolant, wherein the cooling channel 48 makes possible a heat removal from at least one receiving space, in particular heat energy generated by the transformer unit 14, the rectifying device 30 or the drive unit and transmitted to the base body 2. The cooling channel or channels 48 therefore preferably encloses the components to be cooled.

The cooling channels 48 can be generated by corresponding bores in the base body 2. As indicated in FIG. 6, transitions 51 between the cooling channels of the base body 2 can advantageously also be provided for the respective components. In particular, the cooling of the secondary conductors of the transformer unit 14 is advantageous.

The cooling channels 48 may include a galvanic coating as protection from corrosion. The cooling channels 48 formed in the base body 2 largely make long hose connections as are known from the prior art unnecessary. In particular, a cooling of the component is thereby affected at least via the base body 2, and as required, additionally by a transition 50, kept very short, through the cooling channel 48 in the base body 2 to the corresponding component itself. The advantageous cooling device makes possible an optimized cooling without the known exposed hose connections, as well as advantages in the reduced number of the required components, the weight, and the minimized installation space.

For an effective temperature management, a temperature sensor 52 can be disposed at particularly susceptible locations in the base body 2 or directly on the respective components. In the exemplary embodiment according to FIGS. 2 to 6, a temperature sensor 52 is disposed in the vicinity of the transformer unit 14, in particular in contact with the transformer unit 14 or the casting compound surrounding the transformer unit 14. A temperature sensor 52 is particularly preferably disposed on the rectifying device 30 or its diodes. The temperature sensor 52 is in particular connected to a control-line plug 22, advantageously together with the current measurement coil 20, so that the output signals of the temperature sensor 52 are preferably accessible from outside the current source module 1. Using the output signal, the cooling device is preferably controlled in a temperature-dependent manner; however, the use of the temperature sensor 52 is not limited to a coupling to the cooling device, in particular also only an indicator for the state of the current source module 1 can thereby be provided.

According to the embodiment shown in FIG. 6, the base body 2 includes inlet- and outlet-terminals 54. A cooling fluid flows from the inlet terminal 54 through the cooling channels 48 of the base body 2 and through the transformer unit 14. From there, the cooling fluid is guided via a shortest-possible transition 51 back into a cooling channel 48, and from there via an also short transition 51 through the rectifying device 30. In particular, a further transition 51 guides the cooling fluid into a cooling channel 48, from which it is guided, in particular through the power terminal 18, to a joining tool. The joining tool(s) forms/form an external cooling circuit. Via a further terminal, in particular the power terminal 18, the cooling fluid is guided from the external current circuit back into a cooling channel 48 in the base body 2. In particular, it is depicted in FIG. 6 that using transitions 51 the cooling channels 48 still guide the cooling fluid through the drive unit, and ultimately a cooling channel 48 opens at an outlet terminal. FIG. 6 is merely an exemplary embodiment here; a not-depicted embodiment without transitions 51 to the individual components, or the integration of other components also falls within the context of the present disclosure. In addition, the cooling fluid can be coolant or water with or without additives.

The at least one cooling channel 48 is advantageously formed in at least one wall 55, preferably in a plurality of walls 55, preferably in all walls 55 of the base body 2, which wall/walls surrounds/surround the first receiving space 8 and/or further receiving spaces 9. Furthermore, the at least one cooling channel 48 is formed in at least one separating wall 56 of the base body 2, which separating wall 56 separates two receiving spaces from each other. In particular, the separating wall 56 is not depicted in FIG. 6, wherein the separating wall 56 is depicted in FIG. 1. The at least one cooling channel 48 is particularly preferably formed in the base body 2 such that at least two receiving spaces 8, 9 enclose at least one side of the same cooling channel 48, and the receiving spaces 8, 9 are thermally coupled to each other by the cooling channel 48.

FIGS. 7 and 8 show welding guns 58, in particular for electric spot welding. These include a current source module 1 according to one of the above-mentioned embodiments. These welding guns 58 include a first joining tool formed as an immovable electrode arm 6, and a second joining tool, formed as movable electrode arm 60, wherein the immovable electrode arm 6 is connected to the first attachment element 4, and the movable electrode arm 60 is connected to the second linearly movable attachment element 10. The electrode arms 6, 60 include electrodes 62 that are electrically connected to the transformer unit 14. In particular, one electrode 62 is respectively connected to the positive terminal, and one electrode 62 is connected to the negative terminal.

FIG. 7 shows an embodiment as a C gun, wherein the basic design is generally known from the prior art. The control element includes the second attachment element 10, linearly movable along an adjustment axis X, wherein the movable electrode arm 60 is formed on the attachment element. In particular, it can be seen here that the movable electrode arm 60 is supported using support element 50, so that in particular no load acting perpendicular to the adjusting axis X acts on the second attachment element 10 or the control element. Using the control element, the movable electrode arm 60 can thereby move parallel to the adjustment axis X into a joining position and a rest position.

In FIG. 8 a further welding gun 58 is depicted, wherein in FIG. 9 the first and second joining tool, or the electrode arms 6, 60 are depicted separately in a connection to each other. The welding gun 58 according to the embodiment in FIG. 8 is configured as an X gun. Here the immovable electrode arm 6 advantageously includes a rotating bearing 66. The movable electrode arm 60 is in turn rotatably supported on the immovable electrode arm 6 via the rotating bearing 66. In particular, this embodiment arises from FIG. 9. Using a swing arm the movable electrode arm 60 is advantageously pivotably connected to the second attachment element 10 of the control element, so that using the linear movement of the second attachment element 10, the movable electrode arm 60 is rotated around the rotating bearing 66 on the immovable electrode arm 6. The rotating bearing 66 has the particular advantage that it simultaneously represents a supporting function for the movable electrode arm. Only a slight force perpendicular to or angled with respect to the adjusting axis X thereby acts on the second attachment element 10 or the control element.

According to the particular embodiment of the current source module 1 that is depicted in particular in FIG. 6, it includes at least one cooling channel 48. As described, the cooling channel 48 is preferably fluidically connected, in particular via the power terminals 18, to at least one cooling channel 48 of the respective electrode arm 6, 60. The cooling channels or the at least one cooling channel for cooling the respective electrode 62 of the respective electrode arm 6, 60 are preferably formed extending up to the electrode 62.

The cooling channel 48 can preferably form a forward course and a return course for each electrode arm 6, 60. In one embodiment, an electrode arm 6, 60 is connected to a cooling channel 48 formed as a forward course, and the other electrode arm 6, 60 is connected to a cooling channel 48 formed as a return course, wherein the cooling channels 48 of the electrode arms are connected to each other, externally of the current source module 1, via a cooling bridge.

The cooling channel 48 can be integrated in the respective electrode arm 6, 60; alternatively the respective electrode arm 6, 60 includes a guide element, e.g., a groove 64 or arms, in order to guide a hose line, for guiding the cooling fluid, along the electrode arm 6, 60. The hose line can in particular replace or supplement a cooling channel in the electrode arm 6, 60. For example, the supply and return course on the cooling channel can be divided into the electrode arm 6, 60 and a hose line along the electrode arm.

The invention is not limited to the exemplary embodiments shown and described, but rather also comprises all embodiments which work the same way in the sense of the invention. It is emphasized that the exemplary embodiments are not limited to all features in combination, rather each individual partial feature can also have inventive significance in isolation from all other partial features. Furthermore, the invention is so far not yet limited to the combinations of features defined in any specific embodiment, but rather can also be defined by any other combination of specific features of all of the individual features disclosed herein. This means that in principle practically any individual feature of any embodiment can be removed or replaced by another individual feature disclosed elsewhere in the application. In other words, within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

1. A current source module for joining methods with current-generated heat support, in particular for welding guns, the current source module comprising a base body formed monolithically as a single component, which has a first immovable attachment element for connecting a first joining tool and at least one first formed receiving space,
wherein in the first receiving space a control element is disposed including a linearly movable second attachment element for connecting to a second joining tool, and in the first or a further receiving space a transformer unit is disposed for electrical supplying of the joining tool.

2. The current source module according to claim 1, wherein the transformer unit is cast in the receiving space in a materially-bonded manner with the base body.

3. The current source module according to claim 1, wherein a rectifying device is disposed in the first or a further receiving space and is electrically connected to the transformer unit.

4. The current source module according to claim 3, wherein the rectifying device includes diodes that are accessible and exchangeable from outside the base body.

5. The current source module according to claim 1, wherein a drive unit is disposed in active connection with the control element on the base body, so that the control element can move the second attachment element linearly.

6. The current source module according to claim 5, wherein the control element is configured as a spindle and the drive unit as an electric motor, wherein the spindle converts a rotational movement of the electric motor into a linear movement of the second attachment element.

7. The current source module according to claim 5, wherein the drive unit is an electromagnetic linear drive that can move the control element and the second attachment element linearly.

8. The current source module according to claim 7, wherein the electromagnetic linear drive comprises the control element as part of the drive, so that the electromagnetic linear drive is directly connected to the second attachment element.

9. The current source module according to claim 1, wherein a transmission is in active connection with the drive unit and translates a movement of the drive unit and transmits it to the control element, and in particular can adapt the movement to the control element, wherein the transmission and/or the drive unit are disposed in the first and/or a further receiving space of the base body.

10. The current source module according to claim 1, wherein the base body includes two, in particular three receiving spaces, wherein in the second receiving space at least the transformer unit is disposed, and in a first receiving space at least the linearly movable control element is disposed.

11. The current source module according to claim 10, wherein the base body includes at least one cooling channel that can guide a fluidic coolant, wherein the cooling channel enable a heat removal from at least one receiving space, in particular heat energy generated by the transformer unit and transmitted to the base body.

12. The current source module according to claim 11, wherein the at least one cooling channel is formed in at least one wall, preferably in a plurality of walls, preferably in all walls of the base body, which wall/walls surrounds/surround the first receiving space and/or further receiving spaces.

13. The current source module according to claim 11, wherein the at least one cooling channel is formed in at least one separating wall of the base body, which separating wall separates two receiving spaces from each other.

14. The current source module according to claim 11, wherein the at least one cooling channel is formed in the base body such that at least two receiving spaces enclose at least one side of the same cooling channel, and the receiving spaces are thermally coupled to each other by the cooling channel.

15. A welding gun, in particular for electric spot welding, the welding gun comprising:
a current source module according to claim 1,
a first joining tool formed as an immovable electrode arm, and
a second joining tool formed as a movable electrode arm,
wherein the immovable electrode arm is connected to the first attachment element, and the movable electrode arm is connected to the second linearly movable attachment element,
wherein the electrode arms include electrodes electrically connected to the transformer.

16. The welding gun according to claim 15, wherein the welding gun is configured as an X gun, such that the immovable electrode arm includes a rotating bearing, and the movable electrode arm is rotatably supported on the immovable electrode arm via the rotating bearing, and is pivotably connected by a swing arm to the second attachment element of the control element, so that using the linear movement of the second attachment element the movable electrode arm is rotated about the rotating bearing on the immovable electrode arm.

17. The welding gun according to claim 15, wherein the current source module includes at least one cooling channel that is fluidically connected to at least one cooling channel of the movable electrode arm and/or a cooling channel of the immovable electrode arm, wherein the cooling channels or the at least one cooling channel for cooling the electrode is formed extending in the respective electrode arm up to the electrode.
